(19) United States
(12) Patent Application Publication
(10) Pub. No.: US 2021/0091493 A1
(43) Pub. Date: Mar. 25, 2021

(54) REDUCED-FRICTION CARD-EDGE CONNECTOR SOCKET

(71) Applicant: International Business Machines Corporation, Armonk, NY (US)

(72) Inventors: XiYuan Yin, Guangzhou (CN); Qiuyi Yu, Shenzhen (CN); Zhongfeng Yang, Shenzhen City (CN); Tao Song, Shenzhen (CN); Pengcheng Xie, Shenzhen (CN)

(21) Appl. No.: 16/582,079

(22) Filed: Sep. 25, 2019

(51) Int. Cl. H01R 12/72; H01R 13/629

(52) U.S. Cl. CPC H01R 12/725; H01R 13/62966; H01R 12/721

(57) ABSTRACT

A socket for a card-edge connector comprises a bottom frame end, a top frame end, a first frame portion, a second frame portion, and a slot. A card-edge connector inserted into the slot may proceed from the from the top frame end towards the bottom frame end between the first frame portion and second frame portion. The socket may comprise a pin contact in the first frame portion. The pin contact may comprise a bottom pin that protrudes out of the first frame portion into the slot near the bottom frame end, a pin shaft located within the first frame portion and connected to the bottom pin section, and a top pin section connected to the pin shaft and located within the first frame portion. The socket may comprise a pin fulcrum located within the first frame portion. The pin fulcrum may contact the pin shaft at a fulcrum point.

### BACKGROUND

The present disclosure relates to electrical connectors, and more specifically, to card-edge connectors.

A card-edge connector is a connection type between a circuit board and a discrete component. This discrete component may take the form of a socket mounted on a second circuit board, in which case the card-edge connector can be utilized as a connection between the circuit board and second circuit board. In a typical card-edge connector, contact traces are placed directly on one or both sides of a circuit board near or at the edge of the circuit board. A corresponding socket may contain a circuit-board shaped slot and contact pins therein that may interface with the contact traces when the edge of the circuit board is inserted into the slot.

### SUMMARY

Some embodiments of the present disclosure can be illustrated as a socket for a card-edge connector, the socket comprising a bottom frame end and a top frame end. The socket may also include a first frame portion and a second frame portion. The socket may also conclude a slot between the first frame portion and the second frame portion, such that a card-edge connector proceeds from the top frame end towards the bottom frame end between the first frame portion and the second frame portion when inserted into the slot. The socket may also comprise a pin contact in the first frame portion. The pin contact may comprise a bottom pin section that protrudes out of the first frame portion into the slot near the bottom frame end. The pin contact may also comprise a pin shaft located within the first frame portion and connected to the bottom pin section. Finally, the pin contact may also comprise a top pin section connected to the pin shaft and located within the first frame portion. The socket may also comprise a pin fulcrum located within the first frame portion, wherein the pin fulcrum contacts the pin shaft at a fulcrum point. A card edge connector, when inserted into the slot, may push the bottom pin section away from the slot and towards the first frame portion when inserted into the slot. The pin fulcrum may prevent the pin shaft from moving away from the slot at the fulcrum point when the bottom pin section moves away from the slot. This may cause the top pin section to move towards the slot. Finally, the top pin section may press against the card-edge connector when it moves towards the slot.

Some embodiments of the present disclosure can also be illustrated as a card-edge connector on a circuit board, the card-edge connector comprising a first section located near an edge of the circuit board. The first section may be of a first thickness. The card-edge connector may also comprise a second section located between the first section and a center of the circuit board. The second section may be of a second thickness that is greater than the first thickness. The card-edge connector may also comprise contacts located on the second section.

Some embodiments of the present disclosure can also be illustrated as a method of assembling a card-edge connector socket, the method comprising inserting a contact pin into an opening of the socket housing. The pin may be inserted between a slot and a fulcrum. The method may also comprise connecting the contact pin to a pin base. The pin may be shaped such that a circuit board inserted into the slot displaces the pin and causes a portion of the pin to rotate towards the circuit board.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a reduced-friction card-edge connector socket, in accordance with embodiments of the present disclosure.

FIG. 2A depicts a reduced-friction card-edge connector socket as a card is being inserted, in accordance with embodiments of the present disclosure.

FIG. 2B depicts a reduced-friction card-edge connector socket after a card has been fully inserted into the socket, in accordance with embodiments of the present disclosure.

FIG. 3 depicts an example illustration of a cross section of a card-edge connector with right-angle edges, in accordance with embodiments of the present disclosure.

FIG. 4 depicts an example illustration of a cross-section of a card-edge connector with a two-step tapered edge.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to electrical-connector sockets, more particular aspects relate to card-edge connector sockets. While the present disclosure is not necessarily limited to such applications, various aspects of the disclosure may be appreciated through a discussion of various examples using this context.

Typical card-edge connectors take the form of trace contacts (sometimes referred to herein as “contacts”) placed on the surface of a printed circuit board (sometimes referred to herein as a “PCB”) that is designed to be inserted into a PCB-shaped slot in a socket. The socket typically contains contact pins (sometime referred to herein as “pins”) that interface with the trace contacts when the PCB is inserted into the slot. In order to increase the likelihood of the pins making sufficient contact with the trace contacts, the pins in some card-edge connector sockets (sometimes referred to herein as “card-edge sockets” or “sockets”) protrude into the slot until a PCB is inserted into the slot. As the PCB is inserted, the PCB may force the pins away from the center of the slot and into the socket housing. At the same time, the pins may push against the PCB with an equal amount of force, causing the pins to press tightly against the trace contacts on the PCB.

Depending on the use case in which a card-edge connector is applied, there may be multiple benefits to the socket pins pushing against the trace contacts. As previously discussed, applying force to the contacts with the pins may increase the quality of the electrical connection between the pins and contacts, which may increase the integrity of a signal sent through the connection, and may therefore allow higher data rates to be communicated through the connection. Further, because the pins in typical card-edge sockets press against the surface of the PCB (and therefore, the trace contacts) while the PCB is being inserted into the socket slot, the pins often rub against the trace contacts as the PCB is being inserted. As the pins rub the trace contacts, they may wick the trace contacts clean of corrosion or coatings. This wicking, in some instances, may also increase the electrical connection between the pins and contacts, further increasing signal integrity sent through the connection.

However, the force that the socket pins apply to the trace contacts may also lead to negative consequences in some use cases. For example, while wicking trace contacts during insertion may increase signal integrity in some use cases, the amount of force that is typically required to create useful wicking is less than the force that is typically required to maintain reliable contact once the PCB is inserted. For this reason, socket pins often press against the trace contacts with significantly more force than is necessary for wicking.

However, as the force pushing two objects together increases, the friction produced when one of those objects moves in relation to the other (and at least partially perpendicular to that force) also increases. Thus, in instances in which socket pins push against the trace contacts with more force than is necessary for wicking, more friction that is necessary is also created between the socket pin and trace contacts. In some instances, the amount of friction produced may be sufficiently high to scratch, erode, or otherwise damage the trace contacts on the edge-card connector. When these trace contacts are damaged, reliability and signal integrity may be decreased.

Thus, while a high force between socket pins and trace contacts may be required for connection reliability, that same high force may also create friction during PCB insertion that negatively affects connection reliability. Where connection reliability, connector performance, and signal integrity may be particularly important, gold trace contacts may be used. However, because gold contacts are soft, they may be more susceptible to friction during PCB insertion. This has led to thicker contacts being used in use cases in high-importance use cases. Unfortunately, thicker contacts require more contact material, which increases manufacturing cost. This may be especially true when trace contacts are composed of expensive metals, such as gold.

In some use cases, the importance of wicking contacts during PCB insertion may be high enough that the benefits gained from wicking may partially offset the negative effects of the higher-than-necessary force that is used to wick the contacts. For example, in some instances an edge-card connector may be used in an environment with a high amount of airborne impurities that may tend to coat electrical components prior to insertion. In some instances, oxidizing agents may tend to oxidize the outermost layer of the atoms in a trace contact, leading to an oxidized covering over the remainder of the trace contact. In these examples, the coating or oxidized layer may partially insulate the trace contact, reducing signal integrity. In either of these (or other) examples, wicking may remove the coating/oxidized layer.

However, in many use cases wicking contacts results in very little, if any benefit. This may be, for example, because the surrounding environment is relatively clean of airborne impurities and oxidizing agents. In these use cases, the negative effects of the force applied to the trace contacts by the pins may not be significantly mitigated. Without mitigating these negative effects, the relative cost of the negative effects, and the cost required to reduce them (e.g., thicker trace contacts), may be exacerbated.

To address these and other issues, embodiments of the present disclosure utilize a low-friction pin and socket structure that reduces the force applied to trace contacts by socket pins during PCB insertion, but increases the force applied when insertion is nearly completed. Some such embodiments may utilize pin contacts with a bottom pin section, shaft, and top pin section. The bottom pin section may protrude out into the socket slot, causing an edge-card connector to make contact with and deform the pin connector upon insertion. The bottom pin section may push against a pin shaft, which may contact a fulcrum connected to the socket housing. This fulcrum may allow the bottom pin section to be deformed away from the slot, which may cause the top pin section to become deformed in the other direction. In some embodiments, this may reduce or eliminate friction between pin contacts and trace contacts during PCB insertion until shortly before the PCB is fully seated in the socket.

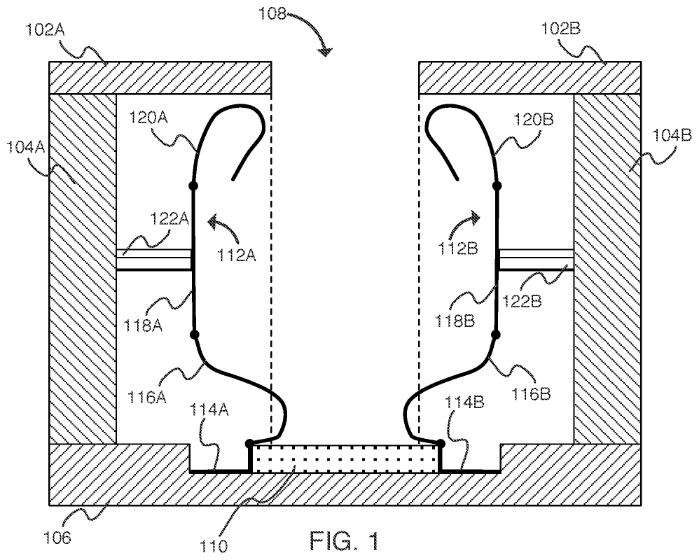

FIG. 1 depicts an example illustration of a cross section of a low-friction edge-connector socket. The socket housing includes top sections 102A and 102B, side sections 104A and 104B, and bottom section 106. A gap between top sections 102A and 102B forms a slot 108 into which a card-edge connector may be inserted. Dashed lines demarcate the width of slot 108 and span from top sections 102A and 102B to PCB seat 110.

Socket pins 112A and 112B are located within each side of the socket housing, and are composed of pin bases 114A and 114B, bottom pin sections 116A and 116B, pin shafts 118A and 118B, and top pin sections 120A and 120B, the transitions between which are demarcated by dots on pins 112A and 112B. Bottom pin sections 116A and 116B protrude into slot 108, and would therefore be contacted by an edge-connector card that is fully inserted into slot 108 and seated on PCB seat 110. Pin bases 114A and 114B may connect contact pins 112A and 112B to another component, such as a motherboard on which the socket is installed. Pin bases 114A and 114B may also secure pins 112A and 112B to the socket (e.g., through pin base 106 and PCB seat 110).

As illustrated, a portion of pin bases 114A and 114B run behind the high portions of bottom section 106. However, in the embodiment shown, an opening is present in the socket housing in bottom section 106 near PCB seat 110. This opening may enable socket pins 112A and 112B to be easily inserted into the socket housing. This may be beneficial, for example when incorporating the embodiments of the present disclosure into current and previous manufacturing processes.

Side sections 104A and 104B may be connected to fulcra 122A and 122B respectively. Fulcra 122A and 122B may contact pin shafts 118A and 118B at fulcra points. If bottom pin sections 116A and 116B shifted away from slot 108, the bottom portion of pin shafts 118A and 118B would be pushed away from slot 108 as well. Pin shafts 118A and 118B would then press against fulcra 122A and 122B at their respective fulcra points, causing the top portions of pin shafts 118A and 118B to be pushed towards the slot. In some embodiments, this design may prevent top pin sections 120A and 120B from contacting trace contacts on an inserted PCB until that PCB is seated or nearly seated on PCB seat 110.

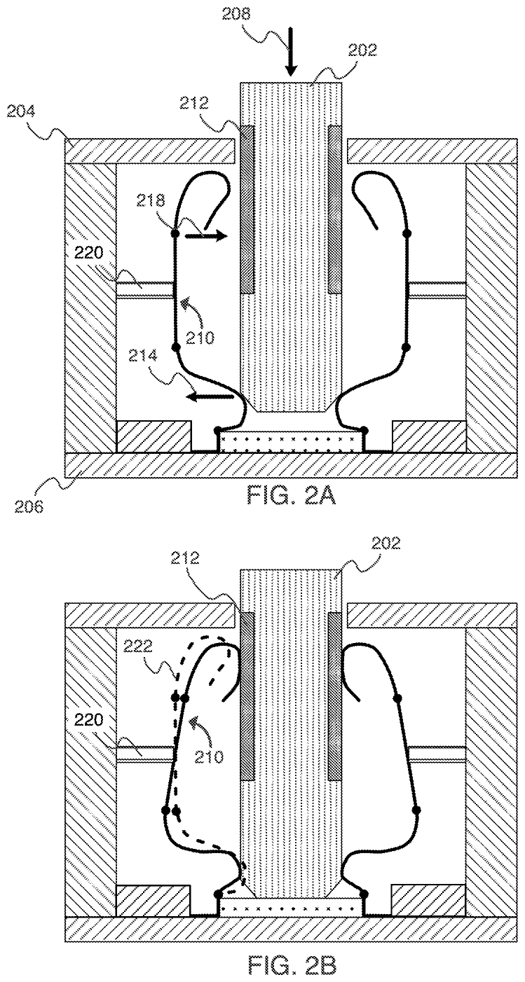

FIG. 2A depicts an example illustration of a cross section of a low-friction edge-connector socket as an edge connector 202 is inserted into the socket. Movement of edge connector 202 as it proceeds from top section 204 towards bottom section 206 is illustrated by movement arrow 208. The socket contains pin 210, which, as illustrated, is still in its default position. In the default position, pin 210 does not touch trace contact 212, at least as illustrated. However, in other embodiments of the present disclosure, a pin may make light contact with a corresponding trace contact on an edge connector that is being inserted into the slot. This may be useful, for example, if wicking the entire trace contact is important for reliability considerations. For example, light contact may provide a normal force between the pin and the trace contact that is barely sufficient to wipe the trace contact clean of impurities.

When edge connector 202 begins to contact pin 210, the bottom section of pin 210 is pushed away from the slot. This movement is illustrated by movement arrow 214. Due to the interaction between pin 210 and fulcrum 220, the top section of pin 210 moves towards the slot when the bottom section of pin 210 moves away from the slot. Further, as is depicted by movement arrow 214, the relative shapes of the bottom section of pin 210 and edge connector 202, as illustrated, cause a high percentage (e.g., 60-99%) of the forces, between the bottom sections of pin 210 and edge connector 202 to be in a horizontal, rather than vertical, plane. For example, 60% of the force between pin 210 and edge connector 202 may be attributed to a vector that propagates perpendicular to the direction of insertion of edge connector 202 and 40% of the force may be attributed to a vector that propagates parallel to the direction of insertion of edge connector 202 (in some use cases, parallel to the primary dimension of edge connector 202). This may be beneficial for multiple reasons. For example, reducing vertical resistance of pin 210 against edge connector 202 may reduce the force that is necessary to insert edge connector 202 into the slot. Further, increasing the horizontal forces between the bottom of edge connector 202 and the bottom of pin 210 increases the retention of edge connector 202 in the socket housing.

FIG. 2B depicts an example illustration of a cross section of the low-friction edge-connector socket of FIG. 2A after the edge connector 202 has been fully inserted into the socket. As illustrated, the bottom portion of pin 210 has been pushed away from the slot by edge connector 202, which has caused pin 210 to bend slightly below the contact with fulcrum 220 (at the fulcrum point). The contact with fulcrum 220 has also caused the top portion of pin 210 to be pushed towards the slot, and the top section of pin 210 is, as illustrated, making contact with trace contact 212.

Also illustrated in FIG. 2B is the previous position and configuration of pin 210 before being deformed by the insertion of edge connector 202. This position and configuration is represented by dashed line 222. By comparing the position and configuration of pin 210 in FIG. 2B with dashed line 222, the effect of inserting edge connector 202 into the socket is made more clear. This comparison also clarifies the ability of the embodiments of the present disclosure to wipe trace contact 212 during insertion. As can be seen by viewing dashed line 222, the first portion of pin 210 to contact trace contact 212 would likely be the right-most portion of pin 210 near the top of pin 210. At this point, horizontal force between pin 210 and trace contact 212 may still be quite light, causing trace contact 212 to lightly brush against the right-most portion of pin 210 as edge connector 202 is being pushed downward into the connector housing.

However, as edge connector 202 is pushed further into the housing, pin 210 is pushed closer to edge connector 202, which may bend pin 210 to increase the surface area of pin 210 that interfaces with trace contact 212. For example, as illustrated, as edge connector 202 is pushed into the slot further and further, the interaction of pin 210 with fulcrum 220 will cause the shaft portion of pin 210 to rotate clockwise. This clockwise rotation may also apply a force on the top portion of pin 210. However, because the top portion of pin 210 is contacting trace contact 212, pin 210 may bend and the top portion of pin 210 may rotate counter clockwise near the trace contact as it moves toward the trace contact. With the shape of pin 210, as illustrated, this would likely increase the surface area of pin 210 that is interface with trace contact 212. Further, this added surface area may press against a portion of trace contact 212 that had just been wiped, strengthening the electrical connection of the pin-contact interface.

In FIG. 2B, a demonstration of a low-friction card-edge-connector socket is illustrated with a PCB with a tapered edge. In some embodiments, this tapered edge may create an interface between a bottom pin section that facilitates deformation of the bottom pin section away from the slot while requiring a small amount of force to insert the PCB. However, it is noteworthy that the function of the low-friction card-edge connector sockets presented herein do not necessarily depend upon the shape of card-edge connectors disclosed in FIG. 2B. Rather, in some embodiments other shapes of card-edge connectors may be utilized without altering the configuration of the socket or pin therein. In other embodiments, tweaks to the shape of the socket, position of the fulcrum, or shape or configuration of the pin structure may be necessary to accommodate the shape of a card-edge connector.

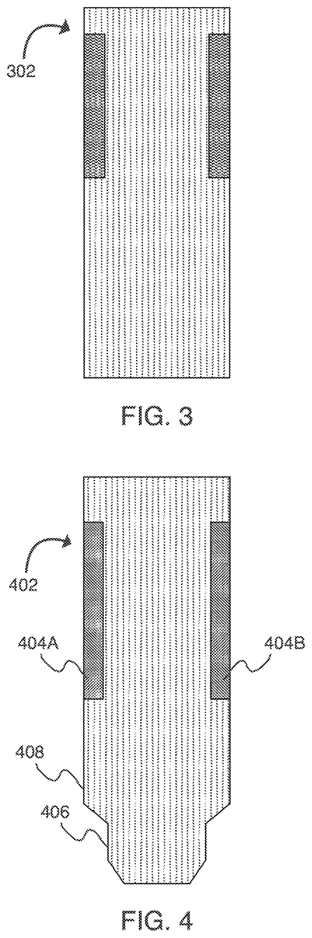

Alternate shapes of card-edge connectors that may be inserted into a low-friction card-edge connector socket are illustrated in FIGS. 3 and 4. FIG. 3 depicts an example illustration of a cross section of a card-edge connector 302 with right-angle edges. Using such a card-edge connector may be beneficial because the right-angle edges of the PCB may be easier or cheaper to manufacturer than the tapered edge of edge connector 202, for example. However, due to the lack of taper, the bottom section of a pin that is designed to interface with the bottom of PCB 302 may function better when it is more vertically oriented (for example, more vertically oriented than pin 210). This may prevent PCB 302 from simply compacting the bottom section of the pin in a vertical direction rather than pushing the bottom section of the pin away from the slot. This may also reduce the amount of force required to insert PCB 302 into the socket, which may increase the lifespan of the socket, pin, or card-edge connector.

FIG. 4 depicts an example illustration of a cross-section of a card-edge connector 402 with a two-step tapered edge. While the tapered PCB in card-edge connector 402 may be more expensive or complicated to make than standard PCBs, the two-step taper may be beneficial to encourage wicking of trace contacts 404A and 404B while reducing the risk of the excess force being applied to trace contacts 404A and 404B. As connector 402 is inserted into a card-edge socket with a corresponding pin design (e.g., socket pin 112A or pin 210), the first step 406 may interface with a bottom section of a socket pin and push it partially away from the slot. However, because step 406 is less than the total thickness of connector 402, the bottom section of the socket pin may be pushed out less by step 406 than second step 408. Thus, in some embodiments, the top section of a pin may only push hard enough on contact 404A, for example, to wipe corrosion off the contact, but not hard enough to significantly increase the connection reliability between the top section of the pin and contact 404A. However, as card-edge connector 402 is inserted more fully into the socket, second-step 408 would begin to push the bottom section of a pin farther away from the slot. This may cause the top section of the pin to press against trace contact 404A with force that is sufficient to significantly increase the connection reliability between the top section of the pin and contact 404A.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A socket for a card-edge connector, comprising:
a bottom frame end and a top frame end;
a first frame portion and a second frame portion;
a slot between the first frame portion and the second frame portion, wherein a card-edge connector proceeds from the top frame end towards the bottom frame end between the first frame portion and second frame portion when inserted into the slot;
a pin contact in the first frame portion, comprising:
a bottom pin section that protrudes out of the first frame portion into the slot near the bottom frame end;
a pin shaft located within the first frame portion and connected to the bottom pin section; and
a top pin section connected to the pin shaft and located within the first frame portion; and
a pin fulcrum located within the first frame portion, wherein the pin fulcrum contacts the pin shaft at a fulcrum point;
wherein the card-edge connector pushes the bottom pin section away from the slot and towards the first frame portion when inserted into the slot;
wherein the pin fulcrum prevents the pin shaft from moving away from the slot at the fulcrum point when the bottom pin section moves away from the slot, causing the top pin section to move towards the slot; and
wherein the top pin section presses against the card-edge connector when it moves towards the slot.

2. The socket of claim 1, wherein the top pin section does not contact the card-edge connector until the card-edge connector is fully inserted into the slot.

3. The socket of claim 1, wherein the top pin section makes light contact with the card-edge connector when the card-edge connector moves in the slot towards the bottom frame end.

4. The socket of claim 3, wherein the light contact causes the top-pin section to wipe the card-edge connector before the card-edge connector is fully inserted into the slot.

5. The socket of claim 3, wherein a portion of the card edge with which the top pin section makes light contact is also contacted by the top-pin section when the card-edge connector is fully inserted into the slot.

6. The socket of claim 1, wherein the socket comprises an opening near a printed-circuit-board seat that enables the pin contact to be inserted into the socket housing.

7. The socket of claim 1, wherein a shape of the bottom pin section, relative to the card-edge connector, causes a high percentage of force between the bottom pin section and the card-edge connector to be attributed to a vector that propagates perpendicular to a direction of insertion of the card-edge connector.

8. The socket of claim 1, wherein the top pin section rotates when the top pin section to move towards the slot, increasing the surface area of the pin contact that interfaces with the card-edge connector.

9. A card-edge connector on a circuit board, the card-edge connector comprising:
a first section located at an edge of the circuit board, wherein the first section is of a first thickness;
a second section located between the first section and a center of the circuit board, wherein the second section is of a second thickness that is greater than the first thickness; and
contacts located on the second section.

10. The card-edge connector of claim 9, wherein partial insertion of the card-edge connector into a connector socket with a corresponding pin design causes the first section to displace a socket pin a first amount.

11. The card-edge connector of claim 10, wherein the first amount of displacement causes the socket pin to wipe the contacts located on the second section.

12. The card-edge connector of claim 9, wherein complete insertion of the card-edge connector into a connector socket with a corresponding pin design causes the second section to displace the socket pin a second amount.

13. The card-edge connector of claim 12, wherein the second amount of displacement causes the socket pin to press against the trace contacts with a force that is sufficient for reliable electrical connection between the socket pin and the trace contact.

14. A method of assembling a card-edge connector socket, the method comprising:
inserting a contact pin into an opening of the socket housing, wherein the pin is inserted between a slot and a fulcrum; and
connecting the contact pin to a pin base;
wherein the pin is shaped such that a circuit board inserted into the slot displaces the pin and causes a portion of the pin to rotate towards the circuit board.

15. The method of claim 14, wherein the contact pin interfaces with the fulcrum when inserted into the socket housing.
